(19) United States
(12) Patent Application Publication
(10) Pub. No.: US 2018/0276123 A1
(43) Pub. Date: Sep. 27, 2018

(54) MEMORY SYSTEM AND CONTROL METHOD

(71) Applicant: Toshiba Memory Corporation, Minato-ku (JP)

(72) Inventor: Hiroki MATSUDAIRA, Funabashi (JP)

(73) Assignee: Toshiba Memory Corporation, Minato-ku (JP)

(21) Appl. No.: 15/700,311

(22) Filed: Sep. 11, 2017

(30) Foreign Application Priority Data
Mar. 21, 2017 (JP) 2017-055004

(51) Int. Cl. G06F 12/02

(52) U.S. Cl. CPC G06F 12/0276

(57) ABSTRACT

According to one embodiment, a memory system is connectable to a host. The memory system includes a non-volatile memory and a memory controller. The non-volatile memory includes a storage area in which data received from the host is stored. The memory controller executes data transfer between the host and the memory. The memory controller executes garbage collection in a case where the quantity of vacant areas in the storage area is less than a threshold. The memory controller adjusts the threshold so that the threshold does not exceed over-provisioning capacity.

### CROSS-REFERENCE TO RELATED APPLICATIONS

This application is based upon and claims the benefit of priority from Japanese Patent Application No. 2017-055004, filed on Mar. 21, 2017; the entire contents of which are incorporated herein by reference.

### FIELD

Embodiments described herein relate generally to a memory system and a control method.

### BACKGROUND

In the related art, a memory system called solid state drive (SSD) is known. The SSD is a device that uses a non-volatile semiconductor memory such as a NAND-type flash memory.

Into the NAND-type flash memory, basically, rewriting of data is impossible. In addition, in the NAND-type flash memory, erasing of data can be performed only in a block unit. Therefore, in the SSD, processing called garbage collection is executed to generate a block including a vacant area.

### BRIEF DESCRIPTION OF THE DRAWINGS

FIG. 1 is a diagram illustrating a configuration example of a memory system according to a first embodiment;

FIG. 2 is a diagram illustrating a configuration example of a NAND memory;

FIG. 3 is a diagram illustrating initiation timing of garbage collection according to the first embodiment;

FIG. 4 is a flowchart illustrating an operation of setting a threshold Th according to the first embodiment;

FIG. 5 is a flowchart illustrating an operation of initiating and stopping the garbage collection according to the first embodiment; and

FIG. 6 is a diagram illustrating initiation timing of garbage Vection according to a second embodiment.

### DETAILED DESCRIPTION

In general, a memory system is connectable to a host. The memory system includes a non-volatile memory and a memory controller. The non-volatile memory includes a storage area in which data received from the host is stored. The memory controller executes data transfer between the host and the memory. The memory controller executes garbage collection in a case where the quantity of vacant areas in the storage area is less than a threshold. The memory controller adjusts the threshold so that the threshold does not exceed over-provisioning capacity.

Exemplary embodiments of a memory system and a control method will be explained below in detail with reference to the accompanying drawings. The present invention is not limited to the following embodiments.

### First Embodiment

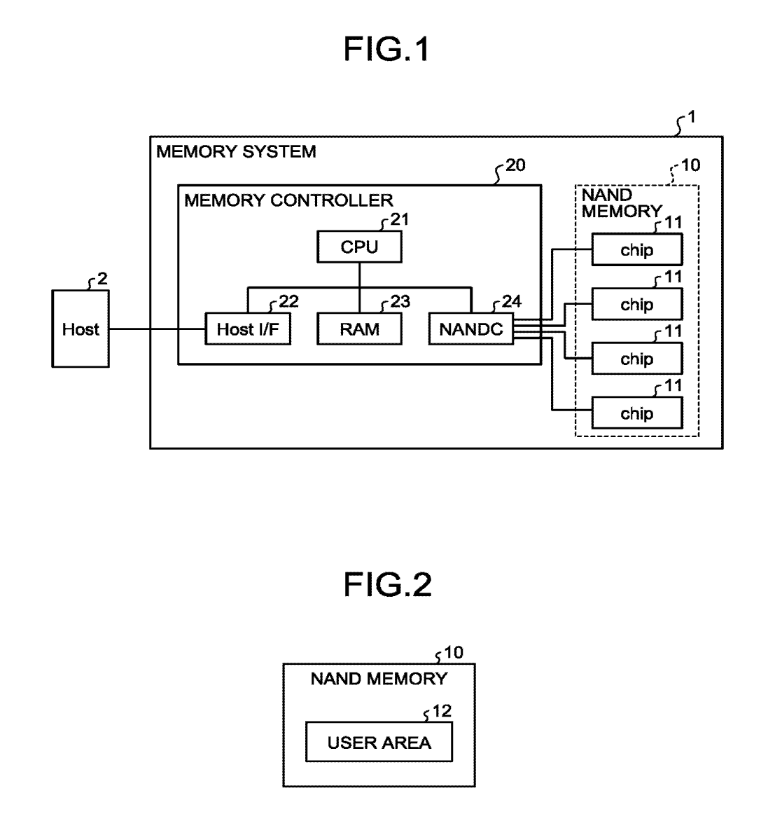

FIG. 1 is a diagram illustrating a configuration example of a memory system according to a first embodiment. A memory system 1 is connected to a host 2 through a predetermined communication interface. Examples of the host 2 include a personal computer, a portable information terminal, a server, and the like. The memory system 1 can receive access requests (a read request and a write request) from the host 2. Each of the access requests is accompanied with a logical address indicating an access destination. The logical address indicates a location in a logical address space which the memory system 1 provides to the host 2. The memory system 1 receives data of that is a write target in combination with a write request.

The memory system 1 includes a NAND type flash memory (NAND memory) 10, and a memory controller 20 that executes data transfer between the host 2 and the NAND memory 10. Furthermore, the memory system 1 may include an arbitrary non-volatile memory instead of the NAND memory 10. For example, the memory system 1 may include a NOR-type flash memory instead of the NAND memory 10.

The NAND memory 10 includes one or more memory chips 11. Here, as an example, the NAND memory 10 includes four memory chips 11. Each of the memory chips 11 includes a plurality of blocks. For example, each of the blocks is a minimum storage area in which data is collectively erased. A block includes a plurality of pages. For example, each of the pages is a minimum storage area which data can be read or written to.

FIG. 2 is a diagram illustrating a configuration example of the NAND memory 10. As illustrated in the diagram, the NAND memory 10 includes a user area 12 in which user data is stored. The user data is data that is received from the host 2. The user area 12 includes a plurality of blocks. Capacity of the user area 12 is noted as a user area size.

It should be noted that the memory controller 20 can handle capacity, the size, and the quantity of data in an arbitrary unit. For example, the memory controller 20 can handle the capacity, the size, and the quantity of data as the number of pages, the number of clusters, or the number of blocks.

Description will return to FIG. 1. The memory controller 20 includes a central processing unit (CPU) 21, a host interface (host I/F) 22, a random access memory (RAM) 23, and a NANDC 24.

The CPU 21 executes a control of the memory controller 20 in accordance with a firmware program. For example, the firmware program is stored in advance in a non-volatile memory such as the NAND memory 10, and is read from the NAND memory 10 at booting up and is executed by the CPU 21.

The RAN 23 is a memory that is used as a buffer or a work area of the CPU 21. A kind of memory that constitutes the RAM 23 is not limited to a specific kind. For example, the RAM 23 is constituted by a dynamic random access memory (DRAM), a static random access memory (SRAM), or a combination thereof.

The host interface 22 executes a control of a communication interface with the host 2. The host interface 22 executes data transfer between the host 2 and the RAM 23 under a control by the CPU 21. The NANDC 24 executes data transfer between the NAND memory 10 and the RAM 23 under a control by the CPU 21.

When transferring data from the host 2 to the NAND memory 10, the CPU 21 buffers the data to the RAM 23, and transfers the data buffered in the RAM 23 to the NAND memory 10. In addition, in a case where read of data is requested from the host 2, the CPU 21 reads out requested data from the NAND memory 10 to the RAM 23, and then transfers the data from the RAM 23 to the host 2.

When transferring data to the NAND memory 10, the CPU 21 determines a write location of the data among an vacant areas. A vacant area is an area in which no data is programmed, and is an area in which new data can be programmed. The CPU 21 maps a program location, which is determined, to a logical address indicating a location of the data.

Here, in a case where, before the program location of the data is mapped to the logical address indicating the location of the data (new data), a program location of another data (old data) had been mapped to the logical address indicating the location of the new data, the program location of the old data becomes, by updating of mapping, in a state in which no logical address is mapped. As a result, the host 2 can read the new data front the memory system 1, but cannot read the old data. User data, which is stored at a location mapped to the logical address, is noted as valid data. User data, which is stored at a location that is not mapped to the logical address, is noted as invalid data.

In this manner, both of the valid data and the invalid data can be retained in the user area 12. The maximum quantity of valid data which the user area 12 can store is referred to as user capacity. The user area size is larger than the user capacity. A difference between the user area size and the user capacity is referred to over-provisioning capacity.

Furthermore, the over-provisioning capacity can be noted in an arbitrary unit such as the number of bytes, the number of pages, the number of clusters, and the number of blocks. In addition, the over-provisioning capacity can be noted by a ratio (percentage) against another capacity such as the user area size or the user capacity.

As consumption of vacant areas is proceeded, a block including vacant areas becomes to be used up. The CPU 21 erases invalid data to generate a block including a vacant area. It is rare that the entirety of pieces of data stored in one block is invalid. Accordingly, actually, the CPU 21 copies valid data, which remains in the block, to another block, and erases the entirety of pieces of data stored in the block that is a copy source. A process of copying the valid data is referred to as garbage collection. A block, which does not include the valid data at all due to the copying of the valid data, is referred to as a free block.

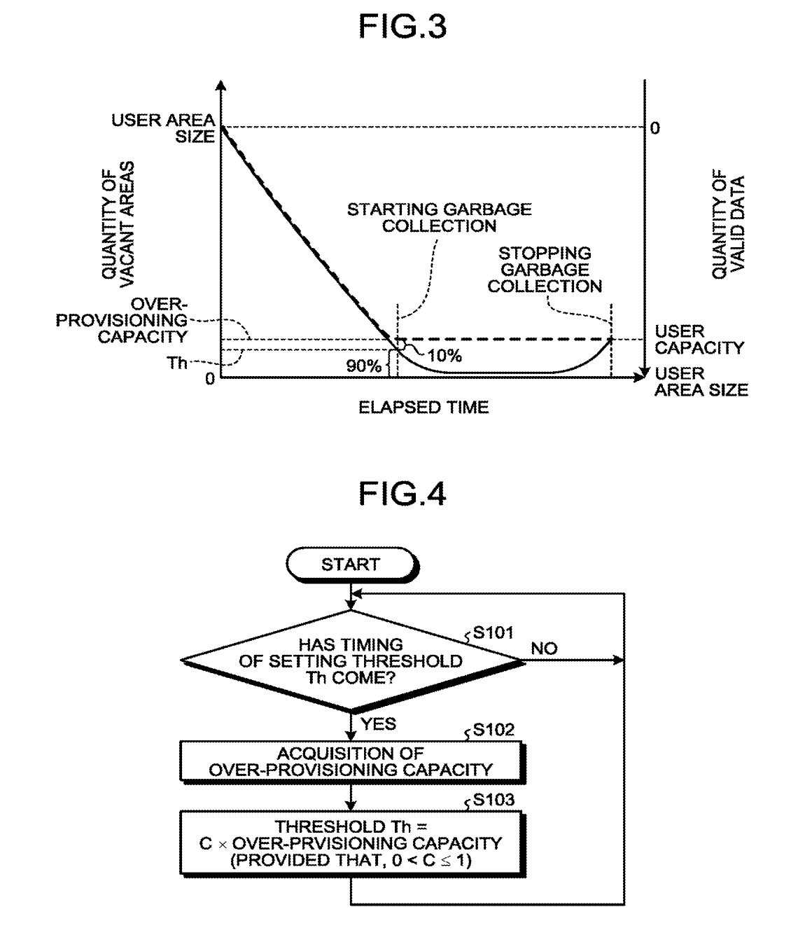

FIG. 3 is a diagram illustrating initiation timing of the garbage collection according to the first embodiment. Here, to explain clearly, description will be given of an example in which sequential write is executed. The sequential write represents an access pattern in which a plurality of write requests are issued so that logical addresses designated as a write destination become continuous.

In FIG. 3, the horizontal axis represents elapsed time. The vertical axis on a left side of the paper represents the quantity of vacant areas in the user area 12, and a solid line represents transition of the quantity of vacant areas in the user area 12. The vertical axis on a right side of the paper represents the quantity of valid data that is retained in the NAND memory 10, and a bold dotted-line represents transition of the quantity of valid data that is retained in the NAND memory 10. In the following description subsequent to the explanation for this drawing, it is assumed that vacant areas includes not only an area in which no data is programmed but also an area that does not include valid data at all due to garbage collection.

As illustrated in FIG. 3, as valid data is written, the quantity of vacant areas decreases. When the quantity of valid data retained in the NAND memory 10 reaches the user capacity, writing of data of which the logical address is the same as a logical address of data which has been previously written to the NAND memory 10 is performed. As a result, the quantity of valid data becomes constant at the user capacity, and the quantity of invalid data increases. Accordingly, a decrease in the quantity of vacant areas also continues even after the quantity of valid data reaches the user capacity.

Then, when the quantity of vacant areas is less than a threshold Th in the first embodiment, the CPU 21 starts the garbage collection. In a case where the quantity of vacant areas is recovered to the threshold Th, the CPU 21 stops the garbage collection.

In the example in FIG. 3, a value obtained by multiplying the over-provisioning capacity by 0.9 is used as the threshold Th. Here, when a had block occurs in the user area 12, the user area size decreases. The user capacity is constant, and thus the over-provisioning capacity decreases due to the decrease in the user area size. In a case where the over-provisioning capacity decreases, the threshold Th is calculated again by using the over-provisioning capacity after the decrease. That is, a value obtained by multiplying the over-provisioning capacity after the decrease by 0.9 is used as the threshold Th. In this manner, the threshold Th is changed, that is, adjusted in correspondence with the over-provisioning capacity. Accordingly, the threshold Th does not exceed the over-provisioning capacity.

If a fixed value is used as the threshold Th, the over-provisioning capacity decreases, and thus the threshold Th becomes larger than the over-provisioning capacity. In this case, when the quantity of valid data reaches the user capacity, the amount of vacant areas is not recovered to the threshold Th. Therefore, the garbage collection is performed constantly, and thereby wear of the NAND memory 10 is accelerated.

In the first embodiment, the threshold Th is maintained to a value that is equal to or less than the over-provisioning capacity. Accordingly, even when the quantity of valid data reaches the user capacity, a situation, in which the garbage collection cannot be stopped, is prevented.

Furthermore, setting of a value, which is obtained by multiplying the over-provisioning capacity by a fixed value such as 0.9 that is larger than 0 and is equal to or less than 1, as the threshold Th is an example of a method of maintaining the threshold Th to a value that does not exceed the over-provisioning capacity. A method of setting the threshold Th is not limited to the method in which the over-provisioning capacity is multiplied by the fixed value as long as the threshold Th is maintained to a value does not exceed the over-provisioning capacity.

In addition, a case where the over-provisioning capacity decreases is not limited to a case where a bad block occurs.

For example, each memory cell, which constitutes a word line, may retain a value of n (n≥1) bit or larger. A mode in which n is 1 is noted as a single level cell (SLC) mode. In a case where a value of n bits is retained in each memory cell, storage capacity per a word line WL becomes the same as a size corresponding to n pages. A mode in which n is 2 is noted as a multi-level cell (MLC) mode. A mode in which n is 3 or larger may also be provided. The modes for each of n noted as a storage mode.

For example, in a case where the CPU 21 changes the storage mode of a certain block that constitutes the user area 12 from the SLC mode to the MLC mode, the size of the user area 12 increases by one block, and the over-provisioning capacity also increases by one block. In contrast, in a case where the CPU 21 changes the storage mode of a certain block that constitutes the user area 12 from the MLC mode to the SLC mode, the size of the user area 12 decreases by one block, and the over-provisioning capacity also decreases by one block.

As described above, it is possible to increase or decrease the over-provisioning capacity by change of the storage mode.

Furthermore, a method changing the storage mode is not limited to a specific method. When the CPU 21 erases a free block and sets the erased block as a write destination of data, the CPU 21 can make a determination on an operation of the block in either the SLC mode or the MLC mode in accordance with an arbitrary method. Although a block in the SLC mode has a smaller capacity than a block in the MLC mode, data can be programmed into the block in the SLC mode at a faster speed than into the block in the MLC mode. Accordingly, in a case where the storage mode of the block after erase is set to the SLC mode, it is possible to improve an instantaneous write speed. In contrast, in a case where the storage mode of the block after erase is set to the MLC mode, the instantaneous write speed becomes slower, but it is possible to retard timing of starting the garbage collection.

It should be noted that, in a case where the quantity of vacant areas is less than the threshold Th, the CPU 21 executes transfer of user data between the host 2 and the NAND memory 10 and the garbage collection in parallel. Accordingly, even after execution of the garbage collection starts, as illustrated in the drawing, the quantity of vacant areas may decrease. After starting the garbage collection, the CPU 21 may performs arbitration between execution of the transfer of user data and the NAND memory 10 and execution of the garbage collection. The CPU 21 may control a ratio for the arbitration based on the quantity of vacant areas. In an example, as the quantity of vacant areas becomes larger, the CPU 21 decreases an executing rate of the garbage collection against an executing rate of the transfer of user data. As the quantity of vacant areas becomes smaller, the CPU 21 increases the executing rate of the garbage collection against the executing rate of the transfer of user data. The executing rate of the garbage collection may be changed discretely or continuously based on the quantity of vacant areas.

It should be noted that “executing the transfer of user data between the host 2 and the NAND memory 10 and the garbage collection in parallel” represents that the transfer of the user data between the host 2 and the NAND memory 10 and the garbage collection are switched with each other in a time-sharing manner, or the garbage collection is executed at the background of partial operation of the transfer of the user data between the host 2 and the NAND memory 10. The partial operation of the transfer is, for example, receiving the user data or a command from the host 2.

Next, description will be given of an operation of the memory system 1 according to the first embodiment. FIG. 4 is a flowchart illustrating an operation of setting the threshold Th according to the first embodiment.

First, the CPU 21 determines whether or not timing of setting the threshold Th has come (S101). In a case where the timing has not come (S101, No), the CPU 21 executes processing in S101 again.

As for S101, the timing of setting the threshold Th may be arbitrarily determined. As an example, in a case where predetermined time, for example, 10 msec has elapsed from timing of setting the threshold Th, the CPU 21 determines that the next timing has come. In a case where the threshold Th is not set even once, the CPU 21 determines that the timing has come.

In another example, the CPU 21 monitors the over-provisioning capacity, and in a case where the over-provisioning capacity varies, the CPU 21 determines that the timing of setting the threshold Th has come.

When the timing of setting the threshold Th has come (S101, Yes), the CPU 21 acquires the over-provisioning capacity (S102).

A method of acquiring the over-provisioning capacity is not limited to a specific method. In an example, the CPU 21 constantly monitors the over-provisioning capacity. For example, the CPU 21 records the over-provisioning capacity in the RAM 23 and the like, and in a case where a bad block occurs, the CPU 21 subtracts capacity of the bad block from the over-provisioning capacity recorded in the RAM 23 and overwrites updates the subtracted over-provisioning capacity on the over-provisioning capacity recorded in the RAM 23. In this manner, the CPU 21 constantly holds the over-provisioning capacity in the RAM 23, and, in S102, reads the over-provisioning capacity from the RAM 23.

In yet another example, in S102, the CPU 21 calculates the over-provisioning capacity by subtracting the number of bad blocks from the number of blocks allocated to the user area 12.

Subsequently to S102, the CPU 21 multiplies the over-provisioning capacity by a constant C, and sets an obtained value as the threshold Th (S103). In addition, the CPU 21 executes processing in S101 again. It should be noted that the constant C is a value that is larger than 0 and equal to or less than 1.

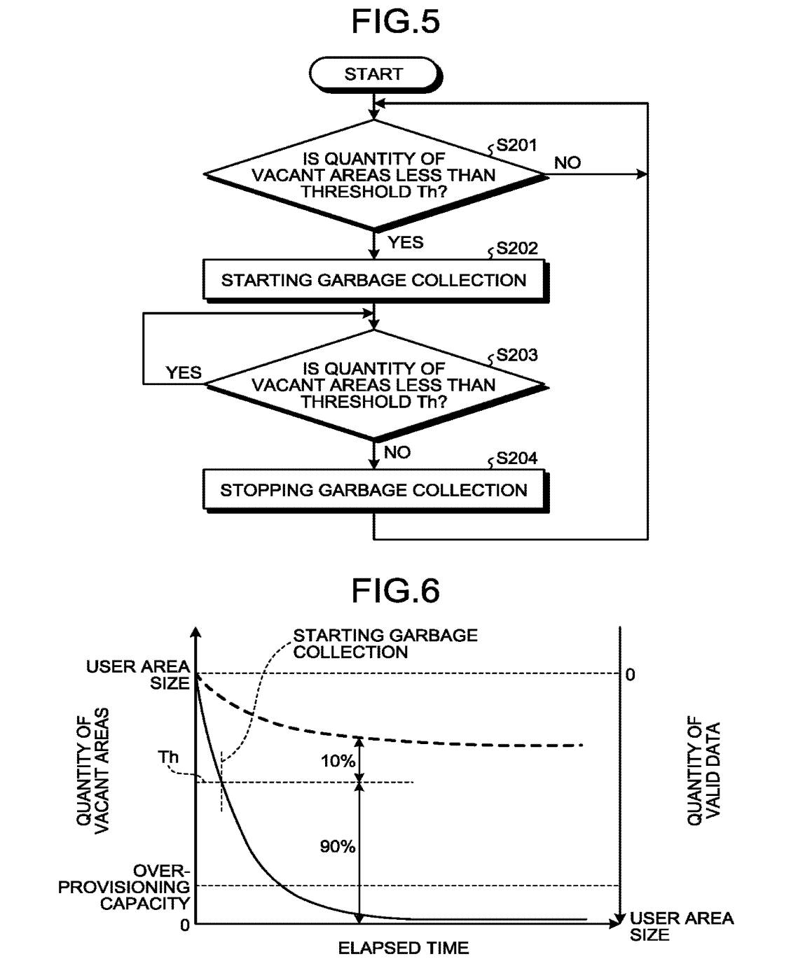

FIG. 5 is a flowchart illustrating an operation of starting and stopping the garbage collection according to the first embodiment.

The CPU 21 determines whether or not the quantity of vacant areas is less than the threshold Th (S201). In a case where the quantity of vacant areas is not smaller than the threshold Th (S201, No), the CPU 21 executes processing in S201 again.

In a case where the quantity of vacant areas is less than the threshold Th (S201, Yes), the CPU 21 starts the garbage collection (S202). Then the CPU 21 determines again whether or not the quantity of vacant areas is less than the threshold Th (S203). In a case where the quantity of vacant area is less than the threshold Th (S203, Yes), the CPU 21 executes processing in S203 again.

In a case where the quantity of vacant areas is not smaller than the threshold Th (S203, No), the CPU 21 stops the garbage collection (S204). Then the CPU 21 executes processing in S201 again.

It should be noted that the processing in a case where the quantity of vacant areas is the same as the threshold Th is not limited to the example described above. For example, in S201, in a case where it is determined that the quantity of vacant areas is the same as the threshold Th, processing in S202 may be executed. In S203, in a case where it is determined that the quantity of vacant areas is the same as the threshold Th, it may not proceed to processing in S204.

As described above, according to the first embodiment, in a case where the quantity of vacant areas in the user area 12 is less than the threshold Th, the CPU 21 executes the garbage collection. The CPU 21 adjusts the threshold Th so that the threshold Th does not exceed the over-provisioning capacity. The adjustment of the threshold Th is performed.

By the above-described configuration, even when the over-provisioning capacity varies, the threshold Th does not exceed the over-provisioning capacity. Accordingly, even in a case where the quantity of valid data reaches the user capacity, a situation, in which the garbage collection cannot be stopped, is prevented, and thus acceleration of wear of the NAND memory 10 is suppressed. As result, the operational lifetime of the memory system 1 is extended, and convenience of the memory system 1 is improved.

In addition, the CPU 21 multiplies the over-provisioning capacity by a fixed value (the constant C1 that is larger than 0 and is equal to or less than 1, and sets a value obtained by the multiplication as the threshold Th.

According to this configuration, it is possible to obtain the threshold Th, which does not exceed the over-provisioning capacity, with a simple algorithm.

In addition, in a case where the quantity of vacant areas in the user area 12 is less than the threshold Th, the CPU 21 executes the data transfer between the host 2 and the NAND memory 10 and the garbage collection in parallel. The CPU 21 may change the executing rate of the garbage collection larger as the quantity of vacant areas in the user area 12 becomes smaller, and may change the executing rate of the garbage collection smaller as the quantity of vacant areas in the user area 12 becomes larger. In other words, the CPU 21 may increase the executing rate of the garbage collection with the decrease in the quantity of vacant areas in the area 12, and may decrease the executing rate of the garbage collection with the increase in the quantity of vacant areas in the user area 12.

According to this configuration, response performance for the host 2 is prevented from rapidly deteriorating at the time of starting the garbage collection.

It should be noted that the CPU 21 may change the executing rate of the garbage collection discretely or continuously.

In a case where the quantity of vacant areas in the user area 12 is larger than the threshold Th, the CPU 21 does not execute the garbage collection.

### Second Embodiment

An operation of a memory system 1 according to a second embodiment is the same as that in the first embodiment except for an algorithm for obtaining the threshold Th. In the second embodiment, the threshold Th is set in correspondence with a quantity obtained by subtracting the quantity of valid data from the user area size.

FIG. 6 is a diagram illustrating starting timing of garbage collection according to the second embodiment. In the drawing, the horizontal axis illustrates elapsed time. The vertical axis on a left side of the paper represents the quantity of vacant areas in the user area 12, and a solid line represents transition of the quantity of vacant areas in the user area 12. The vertical axis on a right side of the paper represents the quantity of valid data that is retained in the NAND memory 10, and a bold dotted-line represents transition of the quantity of valid data that is retained in the NAND memory 10.

The user area size may vary similar to the first embodiment.

In addition, the quantity of valid data may vary. For example, the quantity of valid data increases due to writing from the host 2. The quantity of valid data may decrease due to trimming. The trimming is executed to dissolve mapping of a logical address to a location in the NAND memory 10. The trimming is executed in correspondence with a request (for example, a trimming request) from the host 2.

In the example of the drawing, a value, which is obtained by multiplying a quantity obtained by subtracting the quantity of valid data from the user area size by the constant C (the constant C is, for example, 0.9), is set as the threshold Th. Accordingly, even when the quantity of the user area size and the quantity of valid data vary, the threshold Th does not exceed the quantity that is obtained by subtracting the quantity of valid data from the user area size.

Since the threshold Th is set as described above, for example, even in a case where the user area size becomes less than the user capacity, until the quantity of valid data reaches the user area size, the memory system 1 may continue data transfer between the host 2 and the NAND memory 10 while repeating executing and stopping of the garbage collection.

Furthermore, in a case where the quantity of valid data reaches the user capacity, a quantity, which is obtained by subtracting the quantity of valid data from the user area size, matches the over-provisioning capacity. Accordingly, the behavior of the memory system 1 becomes the same as that in the first embodiment. That is, even in a case where the quantity of valid data reaches the user capacity, a situation, in which the garbage collection cannot be stopped, is prevented.

Setting a value, which is obtained by multiplying the quantity obtained by subtracting the quantity of valid data from the user area size by a fixed value such as 0.9 that is larger than 0 and equal to or less than 1, to the threshold Th is an example of a method of maintaining the threshold Th to a value that does not exceed the quantity obtained by subtracting the quantity of valid data from the user area size. A method of setting the threshold Th is not limited to the method in which the over-provisioning capacity is multiplied by the fixed value as long as the threshold Th is maintained to a value that does not exceed the amount obtained by subtracting the quantity of valid data from the user area size.

As described above, according 2 the second embodiment, in a case where the quantity of vacant areas in the user area 12 is less than the threshold Th, the CPU 21 executes the garbage collection. The CPU 21 adjusts the threshold Th so that the threshold Th does not exceed a quantity obtained by subtracting the quantity of valid data from the use area size.

Accordingly, even in a case where the over-provisioning capacity is less than the user capacity, as long as the quantity of valid data is less than the user capacity, the memory system 1 can continue to be used. That is, convenience of the memory system 1 is improved.

In addition, even in a case where the quantity of valid data reaches the user capacity, a situation, in which the garbage collection cannot be stopped, is prevented, and thus acceleration of wear of the NAND memory 10 is suppressed. As result, the operational lifetime of the memory system 1 is extended, and convenience of the memory system 1 is improved.

In addition, the CPU 21 multiplies a quantity, which is obtained by subtracting the quantity of valid data from the user area size, by a fixed value that is larger than 0 and equal to or less than 1, and sets a value obtained by the multiplication as the threshold Th.

According to this configuration, it is possible to obtain the threshold Th, which does not exceed the quantity obtained by subtracting the quantity of valid data from the user area size, with a simple algorithm.

In addition, in a case where the quantity of vacant areas in the user area 12 is less than the threshold Th, the CPU 21 may execute the data transfer between the host 2 and the NAND memory 10 and the garbage collection in parallel and may change, discretely or continuously, the executing rate of the garbage collection against the executing rate of the transfer of user data based on the quantity of vacant areas in the user are 12. For example, the CPU 21 may increase the executing rate of the garbage collection with the decrease in the quantity of vacant areas in the user area 12, and may decrease the executing rate of the garbage collection with the increase in the quantity of vacant areas in the user area 12.

According to this configuration, response performance for the host 2 is prevented from rapidly deteriorating at the time of starting the garbage collection.

In a case where the quantity of vacant areas in the user area 12 is larger than the threshold Th, the CPU 21 does not execute the garbage collection.

In the embodiments, description has been given on the assumption that the operation exemplified in FIG. 4 and FIG. 5 is realized by the CPU 21 in accordance with the firmware program. A part or the entirety of the operation exemplified in FIG. 4 and FIG. 5 may be realized by a hardware circuit. For example, the memory controller 20 may include a field-programmable gate array (FPGA) or an application specific integrated circuit (ASIC), and a part or the entirety of the functions of the CPU 21 may be realized by the FPGA or the ASIC.

### Third Embodiment

The timing of setting the threshold Th may be arbitrarily determined.

For an example, the CPU 21 measures the elapsed time from the last access from the host 2. In S101, the CPU 21 determines whether the elapsed time exceeds a predetermined time or not. In a case where the elapsed time exceeds the predetermined time, the CPU 21 proceeds to S102. In a case where the elapsed time does not exceed the predetermined time, the CPU 21 repeats S101.

In this manner, the CPU 21 may set the threshold Th at a timing based on the elapsed time from the last access from the host 2. It should be noted that the CPU 21 may proceeds to S102 in a case where the elapsed time becomes to be the predetermined time.

In another example, the CPU 21 monitors rate of receiving data from the host 2. In S101, the CPU 21 determines whether the rate of receiving data is below a predetermined rate or not. In a case where the rate of receiving data is below the predetermined rate, the CPU 21 proceeds to S102. In a case where the rate of receiving data is not below a predetermined rate, the CPU 21 repeats S101.

In this manner, the CPU 1 may set the threshold Th at a timing based on the rate of receiving data from the host 2. It should be noted that the CPU 21 may proceeds to S102 in a case where the rate of receiving data is equal to or less than the predetermined rate.

The CPU 21 may change a storage mode of each block in an arbitrary timing. For example, in S204, the CPU 21 may also changes a storage mode of each of one or more free blocks from the MLC mode to the SIC mode. According to this configuration, the performance of the memory system 1 becomes higher.

### Fourth Embodiment

In the first embodiment, the CPU 21 multiplies the over-provisioning capacity by the constant C, and sets an obtained value as the threshold Th. In the second embodiment, a value, which is obtained by multiplying a quantity obtained by subtracting the quantity of valid data from the user area size by the constant C, is set as the threshold Th. The CPU 21 may set the threshold Th in an arbitrary manner.

For an example, the CPU 21 obtains a quantity by subtracting the quantity of valid data from the quantity of vacant areas. Then the CPU 21 multiplies, by the constant. C, the quantity which is obtained by the subtraction, and sets a value obtained by the multiplication as the threshold Th.

For another example, the CPU 21 obtains a quantity by subtracting the quantity of valid data and the over-provisioning capacity from the quantity of vacant areas. Then the CPU 21 multiplies, by the constant C, the quantity which is obtained by the subtraction, and sets a value obtained by the multiplication as the threshold Th.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and:spirit of the inventions.

What is claimed is:

1. A memory system connectable to a host comprising:
a non-volatile memory including a storage area in which data received from the host is stored; and
a memory controller that executes data transfer between the host and the memory, executes garbage collection in a case where a quantity of vacant areas in the storage area is less than a threshold, and adjusts the threshold so that the threshold does not exceed over-provisioning capacity.

2. The memory system according to claim 1,
wherein the memory controller multiplies the over-provisioning capacity by a fixed value that is larger than 0 and equal to or less than 1, and sets a value obtained by the multiplication as the threshold.

3. The memory system according to claim 1,
wherein the memory controller executes the data transfer and the garbage collection in parallel in a case where the quantity of vacant areas in the storage area is smaller than the threshold, and increases an executing rate of the garbage collection with decrease in the quantity of vacant areas in the storage area, and decreases the executing rate of the garbage collection with increase in the quantity of vacant areas in the storage area.

4. The memory system according to claim 3,
wherein the memory controller changes the executing rate of the garbage collection discretely or continuously.

5. The memory system according to claim 1,
wherein the memory controller does not execute the garbage collection in a case where the quantity of vacant areas in the storage area is larger than the threshold.

6. The memory system according to claim 2,
wherein the memory controller measures an elapsed time from the last access from the host, and sets he threshold at a timing based on the elapsed time.

7. The memory system according to claim 2,
wherein the memory controller monitors rate of receiving data from the host, and sets the threshold at a timing based on the rate.

8. A memory system connectable to a host comprising:
a non-volatile memory including a storage area in which data received from the host is stored; and
a memory controller that executes data transfer between the host and the memory, executes garbage collection in a case where a quantity of vacant areas in the storage area is less than a threshold, and adjusts the threshold so that the threshold does not exceed a first quantity, the first quantity being a quantity obtained by subtracting a second quantity from capacity of the storage area, the second quantity being a quantity of valid data stored in the storage area.

9. The memory system according to claim 8,
wherein the memory controller multiplies the first quantity by a fixed value that is larger than 0 and equal to or less than 1, and sets a value obtained by the multiplication as the threshold.

10. The memory system according to claim 8,
wherein the memory controller executes the data transfer and the garbage collection in parallel in a case where the quantity of vacant areas in the storage area is smaller than the threshold, and increases an executing rate of the garbage collection with decrease in the quantity of vacant areas in the storage area, and decreases the executing rate of the garbage collection with increase in the quantity of vacant areas in the storage area.

11. The memory system according to claim 10,
wherein the memory controller changes the executing rate of the garbage collection discretely or continuously.

12. The memory system according to claim 8,
wherein the memory controller does not execute the garbage collection in a case where the quantity of vacant areas in the storage area is larger than the threshold.

13. The memory system according to claim 9,
wherein the memory controller measures an elapsed time from the last access from the host, and sets the threshold at a timing based on the elapsed time.

14. The memory system according to claim 9,
wherein the memory controller monitors rate of receiving data from the host, and sets the threshold at a timing based on the rate.

15. A control method by a memory controller that controls a non-volatile memory including a storage area in which data received from a host is stored, the control method comprising:
executing data transfer between the host and the memory;
executing garbage collection in a case where a quantity of vacant areas in the storage area is smaller than a threshold; and
adjusting the threshold so that the threshold does not exceed over-provisioning capacity.

16. The control method according to claim 15, further comprising:
multiplying the over-provisioning capacity by a fixed value that is larger than 0 and equal to or less than 1, and setting a value obtained by the multiplication as the threshold.

17. The control method according to claim 15, further comprising:
executing the data transfer and the garbage collection in parallel in a case where the quantity of vacant areas in the storage area is smaller than the threshold;
increasing an executing rate of the garbage collection with decrease in the quantity of vacant areas in the storage area; and
decreasing the executing rate of the garbage collection with increase in the quantity of vacant areas in the storage area

18. The control method according to claim 17,
wherein the garbage collection is changed discretely or continuously.

19. The control method according to claim 16 further comprising
not executing the garbage collection in a case where the quantity of vacant areas in the storage area is larger than the threshold.

20. The control method according to claim 16 further comprising:
measuring an elapsed time from the last access from the host; and
setting the threshold at a timing based on the elapsed time.
